(19) United States
(12) Patent Application Publication
(10) Pub. No.: US 2004/0090123 A1
(43) Pub. Date: May 13, 2004

(54) Car-used burglarproof lock capable of controlling power on/off of the car

(76) Inventor: Wen-Yinn Wu, Kaohsiung (TW)

Correspondence Address: PRO-TECHTOR INTERNATIONAL, 20775 Norada Court, Saratoga, CA, 75070-3018, US

(21) Appl. No.: 10/293,033

(22) Filed: Nov. 12, 2002

(51) Int. Cl. E05B 17/00; B60R 25/04

(52) U.S. Cl. 307/10.3

(57) ABSTRACT

Car-used burglarproof lock capable of controlling power on/off of the car. By means of unlocking/locking the lock core of the burglarproof lock, a remote controlling unit hidden in the burglarproof lock is controlled. By means of remote controlling unit, a receiving controlling unit disposed in a hidden place of the car is controlled to identify and go into standby cut off state (or immediate cut off state) or go into power on state for discharging standby cut off state (or immediate cut off state). Accordingly, the car-used burglarproof lock has both mechanical burglarproof effect and electronic standby cut off (or immediate cut off) burglarproof effect.

### BACKGROUND OF THE INVENTION

The present invention is related to a car-used burglarproof lock capable of controlling power on/off of the car. The car-used burglarproof lock has both mechanical burglarproof effect and electronic standby cut off (or immediate cut off) burglarproof effect.

Car-used burglarproof devices can be divided into mechanical type and electronic type. The mechanical type of car-used burglarproof locks serve to lock the steering wheel lock, handbrake lever, brake pedal, clutch pedal, etc. The electronic type of car-used burglarproof devices serve to emit an alarm and control the opening/closing of the circuit of the car. These two types of car-used burglarproof devices are different from each other in manufacturing and use. In order to protect the car, some consumers solely purchase the mechanical type of car-used burglarproof lock, while some users solely install the electronic type of car-used burglarproof devices. Most of the purchasers will purchase both the mechanical and electronic types of car-used burglarproof devices. However, in the above cases, there are still some shortcomings as follows:

1. With respect to the mechanical type of car-used burglarproof lock, the lock body of the burglarproof lock is easy to damage by prying or cutting.

2. With respect to the electronic type of car-used burglarproof device, the remote controlling code is easy to discharge. This is because that it is easy to detect and record and randomly scan and decode the code.

3. In the case that both the mechanical and electronic types of car-used burglarproof devices are used, it is inconvenient to always carry both the key and remote controller.

### SUMMARY OF THE INVENTION

It is therefore a primary object of the present invention to provide a car-used burglarproof lock having both mechanical burglarproof effect and electronic burglarproof effect. Therefore, it is no more necessary to carry both the key and remote controller. Also, the manufacturing cost and price of the car-used burglarproof lock are lowered.

The present invention can be best understood through the following description and accompanying drawings wherein:

### BRIEF DESCRIPTION OF THE DRAWINGS

FIG. 1 is a plane view of the burglarproof lock of the present invention;

FIG. 2 is a sectional view showing the arrangement of the remote controlling unit of the present invention;

FIG. 3 shows the remote controlling unit of the present invention; and

FIG. 4 shows the receiving controlling unit of the present invention.

### DETAILED DESCRIPTION OF THE PREFERRED EMBODIMENT

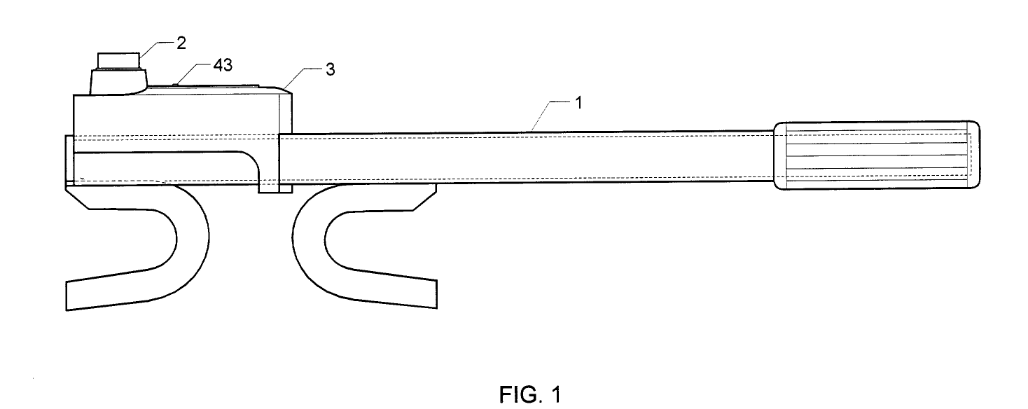

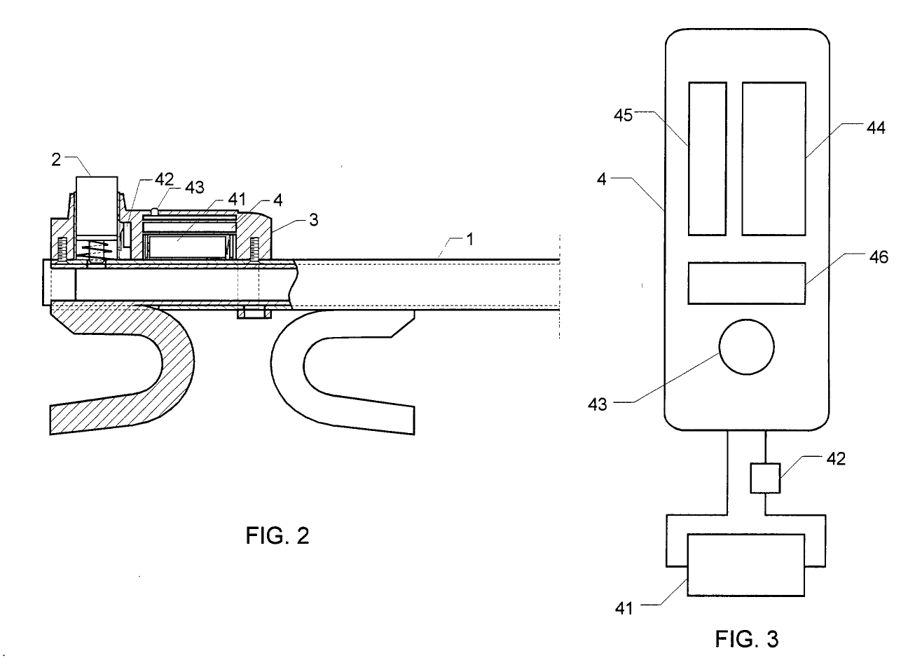

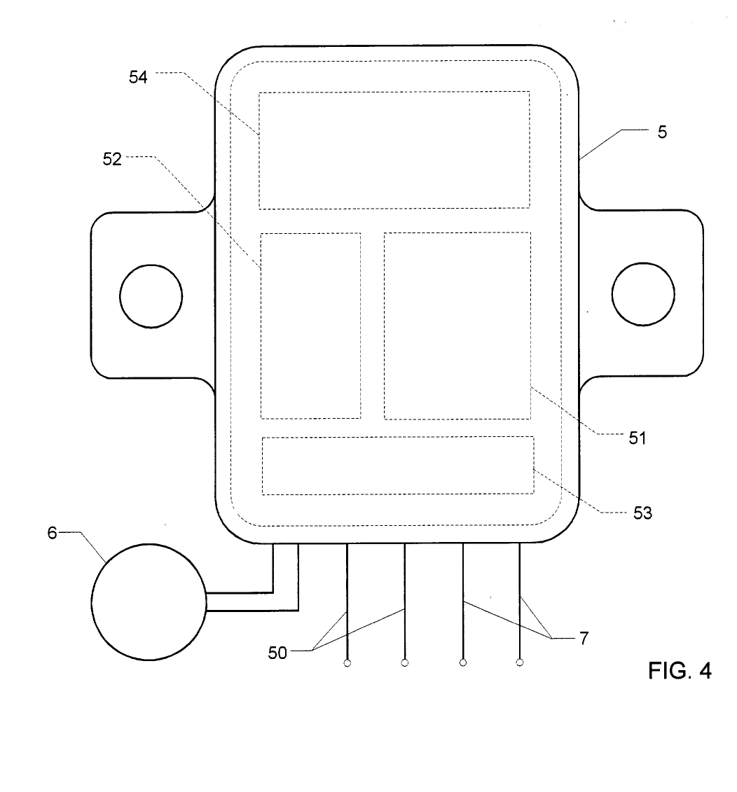

Please refer to FIGS. 1 and 2. The present invention includes a burglarproof lock 1, a lock core 2, a lock core housing 3, a remote controlling unit 4 and a receiving controlling unit 5 disposed in a hidden place in the car.

The burglarproof lock 1 can be any of car-used burglarproof locks with locking function, such as steering wheel lock, shift lever lock, handbrake lever lock, brake pedal lock, clutch pedal lock, etc. In this embodiment, the steering wheel lock is exemplified. However, the scope of the present invention is not limited to this embodiment.

The present invention is characterized in that the car burglarproof lock 1 has a lock core housing 3 and a lock core 2 for controlling unlocking/locking of the burglarproof lock 1. The lock core 2 can be a press-type lock core or a rotary lock core. In this embodiment, the press-type lock core is exemplified. By means of unlocking/locking the lock core 2, a switch 42 is controlled to determine whether the remote controlling unit 4 should transmit a signal code or not.

The remote controlling unit 4 is disposed in the anti-damage lock core housing 3 and equipped with a cell 41, a controlling switch 42, LED light 43, computer chip 44, memory 45 and antenna 46. The cell 41 is always connected with the computer chip 44. The computer chip 44 is turned on/off in such a manner that the switch 42 is switched on/off to change the original high-frequency or low-frequency state. The frequency conforms with the preset acting frequency to make the cell 41 power on the computer chip 44 for a set number of seconds. Accordingly, the computer chip 44 acts for the preset number of seconds. (The cell 41 will power on the computer chip 44 for the preset number of seconds and then automatically stop so as to avoid consumption of the power.) The memory 45 and the antenna 46 emit standby cut off (or immediate cut off) signal code or power on signal code to the receiving controlling unit 5 disposed in a place hidden in the car to activate or discharge the standby cut off (or immediate cut off) state. The power on signal code emitted when the lock core 2 is unlocked memorized by the remote controlling unit 4 is composed of a first emitted first set of power on signal code (pause for a very short time) and a then continuously emitted second set of confirmation power on signal code. The first set of power on signal code is different from the second set of confirmation power on signal code. The confirmation power on signal code can be composed of the first set of power on signal code and a different set of signal code added thereto. The standby cut off (or immediate cut off) signal code emitted when the lock core 2 is locked memorized by the remote controlling unit 4 is a set of standby cut off (or immediate cut off) signal code. The standby cut off (or immediate cut off) signal code is different from the power on signal code so as to prevent the single signal code from being easily detected and recorded and scanned and decoded.

The receiving controlling unit 5 includes an input power cable 50, computer chip 51, memory 52, antenna 53, relay breaker 54, small speaker 6 and breaking cable 7 or other connecting cable with additional function, such as additional LED flicker, buzzer connected to other burglarproof device, in-car telephone for automatically informing the owner, making the car running computer stop operating, transmitting radio signal to make the receiver carried by the owner emit a sound or vibrate, etc. When the antenna 53 receives the standby cut off (or immediate cut off) signal code or power on signal code, the computer chip 51 and the memory 52 identify the signal code to generate standby cut off (or immediate cut off) state or power on state. In the case that the received signal code is the standby cut off (or immediate cut off) signal code, the receiving controlling unit 5 goes into the standby cut off (or immediate cut off) state to make the small speaker 6 emit a sound twice (the number can be set). Before the receiving controlling unit 5 receives the power on signal code for discharging the standby cut off state, when the ignition switch of the car is turned to on, the receiving controlling unit 5 will make it power off.

When the remote controlling unit 4 emits power on signal code, the receiving controlling unit 5 identifies and then discharges the standby cut off (or immediate cut off) state, whereby when the ignition switch of the car is turned to on, the power is supplied. In addition, after the car is started, the receiving controlling unit 5 will not receive any signal code transmitted from the remote controlling unit 4 until the ignition switch is turned to off and the engine is turned off. Then the receiving controlling unit 5 is restored to receive the signal code sent from the remote controlling unit 4.

The present invention has the following advantages:

1. The lock core of the mechanical car-used burglarproof lock can at the same time control the transmission of signal code of the electronic burglarproof device. Therefore, it is unnecessary to use and carry a manually operated remote controller.

2. In case that the lock core of the mechanical car-used burglarproof lock is not unlocked and the lock body is damaged and detached and the burglarproof device does not transmit and receive the signal code discharging the standby cut off (or discharging immediate cut off) and power on signal code, it is still impossible to start the car.

3. The standby cut off (or immediate cut off) signal code and power on signal code are different codes so as to prevent the signal code from being detected and recorded and scanned and decoded.

4. When the lock core of the car-used burglarproof lock is not normally unlocked, double burglarproof effects of burglarproof lock and burglarproof device are achieved.

5. Low cost and good safety burglarproof effect.

6. High industrial utility and value.

The above embodiment is only used to illustrate the present invention, not intended to limit the scope thereof. Many modifications of the above embodiment can be made without departing from the spirit of the present invention.

What is claimed is:

1. Car-used burglarproof lock capable of controlling power on/off of the car, comprising a burglarproof lock, a lock core, a lock core housing, a remote controlling unit and a receiving controlling unit disposed in a hidden place in the car, wherein the burglarproof lock can be any of car-used burglarproof locks with locking function, the burglarproof lock having a lock core housing and a lock core for controlling unlocking/locking of the burglarproof lock, the lock core being a press-type lock core or a rotary lock core, whereby by means of unlocking/locking the lock core, the transmission of the signal code of the remote controlling unit disposed on the burglarproof lock is controlled, said car-used burglarproof lock being characterized in that by means of unlocking/locking the lock core, the switch on/off of a switch is controlled to control whether the remote controlling unit should transmit a standby cut off signal code and power on signal code or not, the standby cut off signal code and power on signal code controlling the hidden receiving controlling unit, whereby the receiving controlling unit according to the received signal code generates the standby cut off state and power on state of the car power.

2. Car-used burglarproof lock capable of controlling power on/off of the car as claimed in claim 1, wherein the standby cut off signal code can be immediate cut off signal code to generate immediate cut off state.

3. Car-used burglarproof lock capable of controlling power on/off of the car as claimed in claim 1, wherein the remote controlling unit is disposed in the anti-damage lock core housing and equipped with a cell, a controlling switch, LED light, computer chip, memory and antenna.

4. Car-used burglarproof lock capable of controlling power on/off of the car as claimed in claim 1, wherein the cell is always connected with the computer chip, the computer chip being turned on/off in such a manner that switch is switched on/off to change the original high-frequency or low-frequency state, the frequency conforming with the preset acting frequency to make the cell power on the computer chip for a set number of seconds, whereby the computer chip acts for the preset number of seconds, the memory and the antenna emitting standby cut off (or immediate cut off) signal code or power on signal code.

5. Car-used burglarproof lock capable of controlling power on/off of the car as claimed in claim 1, wherein the power on signal code memorized by the remote controlling unit is composed of a first emitted first set of power on signal code and a then continuously emitted second set of confirmation power on signal code.

6. Car-used burglarproof lock capable of controlling power on/off of the car as claimed in claim 1, wherein the second set of confirmation power on signal code emitted by the remote controlling unit is composed of the first set of power on signal code and a different set of signal code added thereto.

7. Car-used burglarproof lock capable of controlling power on/off of the car as claimed in claim 1, wherein the receiving controlling unit includes an input power cable, computer chip, memory, antenna, relay breaker, small speaker and breaking cable and other connecting cable with additional function, such as additional LED flicker, buzzer connected to other burglarproof device, in-car telephone for automatically informing the owner, making the car running computer stop operating, transmitting radio signal to make the receiver carried by the owner emit a sound or vibrate, etc.

8. Car-used burglarproof lock capable of controlling power on/off of the car as claimed in claim 1, wherein when the antenna of the receiving controlling unit receives the standby cut off (or immediate cut off) signal code or power on signal code, the computer chip and the memory identify the signal code to generate standby cut off (or immediate cut off) state or power on state.

9. Car-used burglarproof lock capable of controlling power on/off of the car as claimed in claim 1, wherein in the standby cut off state, when the ignition switch of the car is turned to on, the receiving controlling unit will make the power of the car automatically cut off, while in power on state, when the ignition switch of the car is turned to on, the car can be started and when the ignition switch of the car is not turned off, the receiving controlling unit does not receive the signal code emitted from the remote controlling unit.

10. Car-used burglarproof lock capable of controlling power on/off of the car as claimed in claim 1, wherein when the receiving controlling unit receives the power on signal code, the receiving controlling unit identifies and then discharges the standby cut off (or immediate cut off) state, whereby when the ignition switch of the car is turned to on, the power is supplied and after the car is started, the receiving controlling unit will not receive any signal code transmitted from the remote controlling unit until the ignition switch is turned to off and then the receiving controlling unit is restored to receive the signal code sent from the remote controlling unit.
